(19) United States
(12) Patent Application Publication
(10) Pub. No.: US 2011/0198469 A1
(43) Pub. Date: Aug. 18, 2011

(54) HOOKING DEVICE FOR DOOR DECORATIONS

(76) Inventor: Tsung-Wei Chen, Changhua City (TW)

(21) Appl. No.: 12/518,372

(22) PCT Filed: Apr. 22, 2009
(86) PCT No.: PCT/CN2009/071393

§ 371 Date: Jun. 9, 2009

(51) Int. Cl. F16B 45/00

(52) U.S. Cl. 248/304

(57) ABSTRACT

A hooking device for door decorations includes a bracket which can be hung on a top end of the door. The bracket has a first connecting portion and the first connecting portion connects with a flexible sheet. The flexible sheet has a hook body at an end opposite to the bracket. The bracket can be hung on the door, and flexible sheet can naturally hang at one lateral side of the door due to its gravity, the hook body can hook required decorations. By means of the flexible sheet being foldable, the hook body can be received in an interior of the bracket so that the hooking device can easily be stored and used.

### BACKGROUND

1. Field of the invention

The present invention relates to decorations, and more particularly to a hooking device for door decorations, the hooking device can easily be stored and used.

2. Description of the Related Art

Presently, in festivals, decorations are often hung on the door of a house for increasing festival atmosphere. For example, in Christmas, or Spring Festival, Christmas decorations or festival mascots are hung on the door.

In the conventional hooking devices for door decorations disclosed in U.S. Pat. No. D 455,669S and U.S. Pat. No. D 536,882S, the body from a bracket to a hook body is a rigidity structure, causes its volume can not be reduced and will occupied more space in package and transportation, which increases its sale cost.

In the conventional hooking devices for door decorations disclosed in U.S. Pat. No. 6,575,416B1, U.S. Pat. No. 6,311,851B1, and U.S. Pat. No. 5,645,178, the body from a bracket to a hook body is a rigidity structure, causes its volume can not be reduced. Despite it has length adjusting structure, its structure is complicated.

Most of the conventional hooking devices for door decorations are of integrally formed structure or of complicated structure, cause it occupies a large volume after being used, and results a troublesome of storage and a large volume of transportation, not only increases its transportation cost but also is not of environment protection.

### BRIEF SUMMARY

For the usages of the conventional hooking device for door decorations being still have shorting comings of unconvenient to be stored, occupying large volume of transportation, and high cost, inventors design out the present invention.

The present invention provides a hooking device for door decorations, which can be easily stored, greatly decreases its transportation volume and transportation cost, and can further simplify its structure and is convenient to be used.

The present hooking device for door decorations includes a bracket of n-shaped cross section. The bracket has two lateral wings respectively formed at its opposite sides. One of the lateral wings has a first connecting portion at its bottom end and the first connecting portion connects with a flexible sheet. The flexible sheet has a first end and a second end, and the first end connects with the first connecting portion. The flexible sheet has a hook body and the hook body has a hook portion. The hook body connects with a second connecting portion, and the second connecting portion connects with the second end of the flexible sheet.

### BRIEF DESCRIPTION OF THE DRAWINGS

These and other features and advantages of the various embodiments disclosed herein will be better understood with respect to the following description and drawings, in which like numbers refer to like parts throughout, and in which:

FIG. 1 is an exploded, tri-dimensional view of an embodiment of the present invention.

FIG. 2 is an assembled, tri-dimensional view of an embodiment of the present invention.

FIG. 3 is a tri-dimensional view of a storage state of an embodiment of the present invention.

FIG. 4 is a tri-dimensional view of a usage state shown an embodiment of the present invention being applied to a door.

FIG. 5 is an assembled, tri-dimensional view of an embodiment of the present invention.

FIG. 6 is a tri-dimensional view shown an assembling operation of an embodiment of the present invention.

FIG. 7 is a tri-dimensional view of a first end of a flexible sheet of FIG. 6.

FIG. 8 is an assembled, tri-dimensional view of an embodiment of the present invention.

FIG. 9 is an assembled, tri-dimensional view of an embodiment of the present invention.

FIG. 10 is an exploded, tri-dimensional view of an embodiment of the present invention.

FIG. 11 is an assembled, tri-dimensional view of FIG. 10.

FIG. 12 is a tri-dimensional view shown a flexible sheet of FIG. 11 being in a shortening length usage state.

FIG. 13 is an exploded, tri-dimensional view of an embodiment of the present invention.

FIG. 14 is assembled, tri-dimensional view of FIG. 13.

FIG. 15 is an assembled, tri-dimensional view of an embodiment of the present invention.

FIG. 16 is a tri-dimensional view of an embodiment of a bracket of FIG. 15.

FIG. 17 is an exploded, tri-dimensional view of an embodiment of the present invention.

FIG. 18 is an assembled, partly enlarged tri-dimensional view of a rear side of FIG. 17.

FIG. 19 is an exploded, partly enlarged tri-dimensional view of a rear side of FIG. 17.

### DETAILED DESCRIPTION

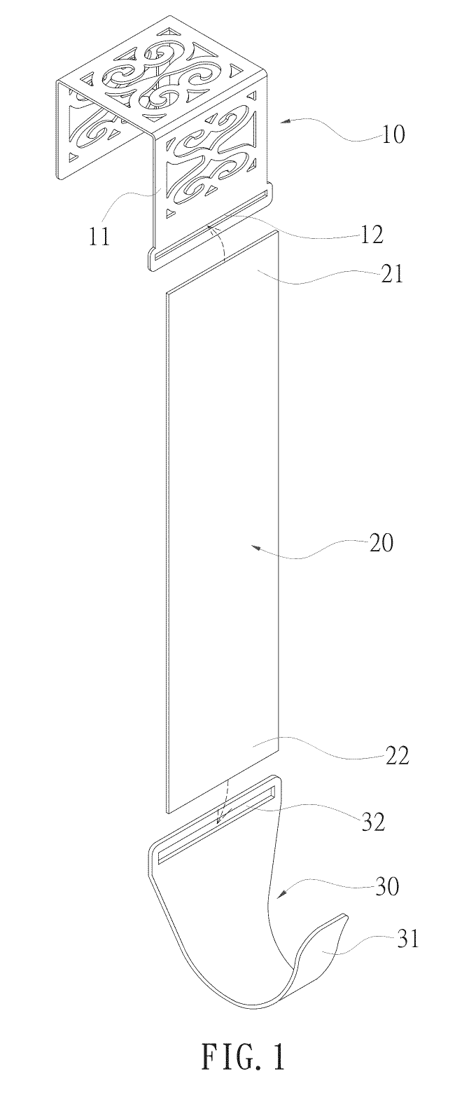

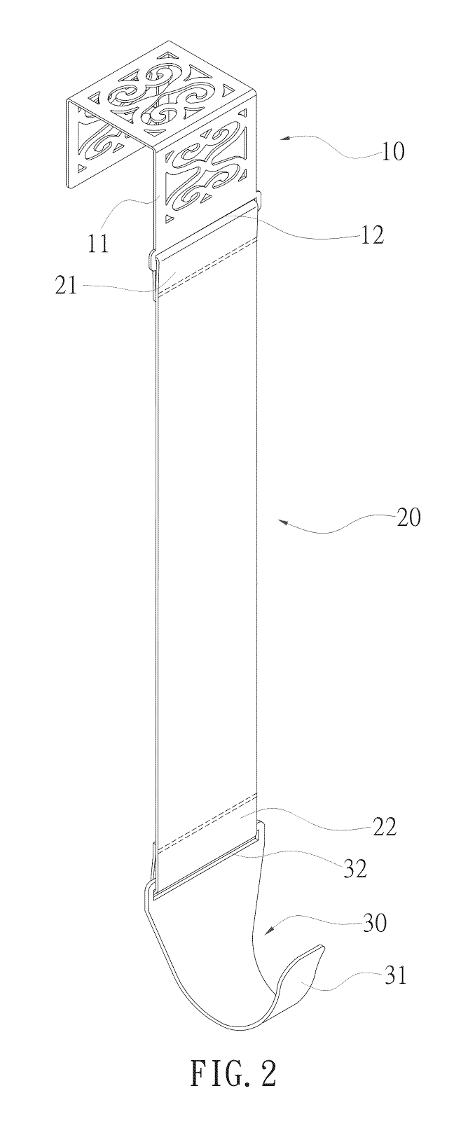

Referring to FIGS. 1 and 2, a hooking device for door decorations includes a bracket 10, a flexible sheet 20 and a hook body 30.

The bracket 10 has an n-shaped configuration. The bracket 10 includes two lateral wings 11 respectively formed at its opposite sides. One of the lateral wings 11 has a first connecting portion 12 at its bottom end, and the first connecting portion 12 includes a slot hole.

The flexible sheet 20 has a first end 21 and a second end 22. The first end 21 passes through the first connecting portion 12, and is bent downwardly and sewed together with a main body of the flexible sheet 20.

The hook body 30 has a hook portion 31 and a second connecting portion 32 upwardly and integrally extending from a terminal end of the hook portion 32. The second connecting portion 32 includes a slot hole. The second end 22 of the flexible sheet 20 passes through the second connecting portion 32 of the hook body 30, and is bent upwardly and sewed together with the main body of the flexible sheet 20, so that two opposite ends, i.e., the first end 21 and the second end 22, of the flexible sheet 20 is respectively fixed to the bracket 10 and the hook body 30. Therefore, the assembly of the hooking device is accomplished.

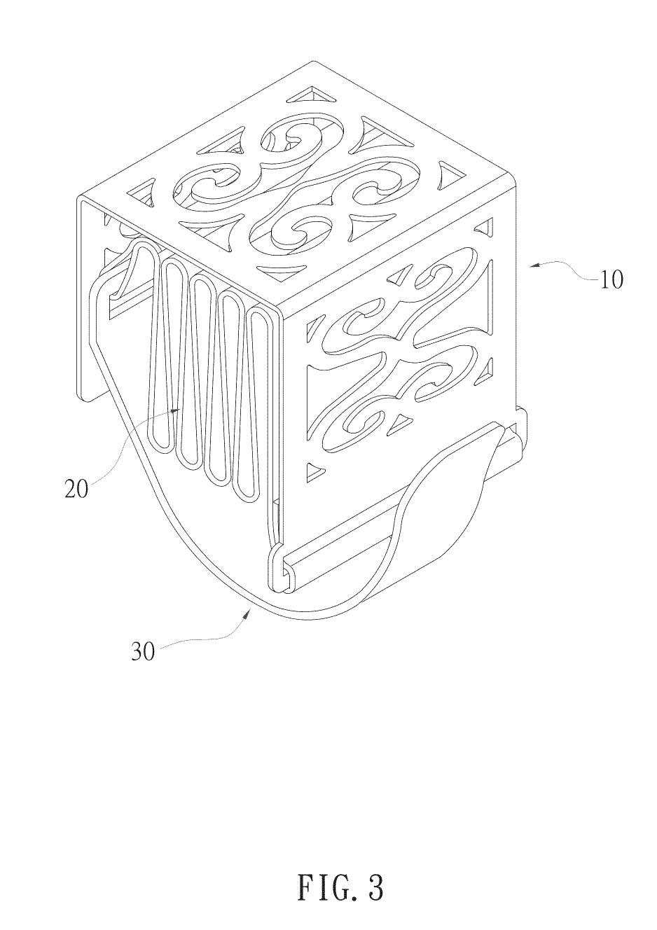

Referring to FIG. 3, during storage of the hooking device, due to its flexible and foldable characteristics, the flexible sheet 20 is easily to be folded and received in an interior of the bracket 10, and the second connecting portion 32 of the hook body 30 is able to contact with an interior lateral surface of the bracket 10. Thus, the hooking device is in a minimum volume, and therefore, is convenient to be stored by users after being used, or can greatly decrease its volume during transportation and decrease its transportation cost.

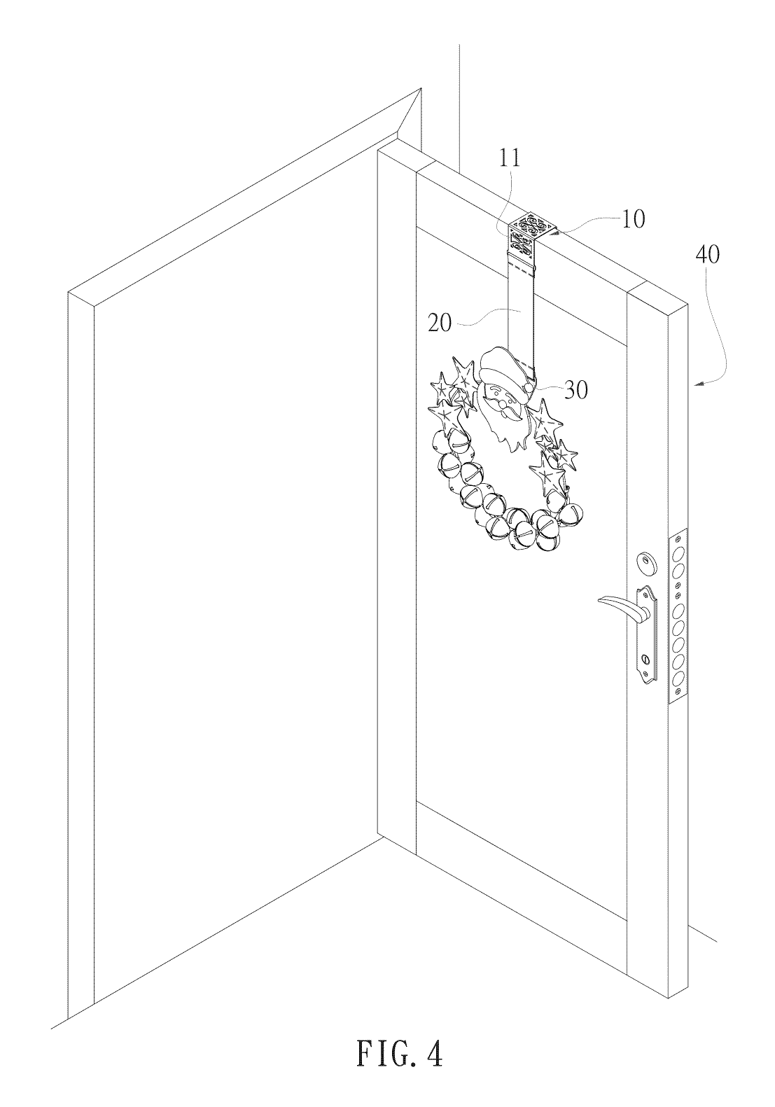

Referring to FIG. 4, during usage of the hooking device, the bracket 10 can be hung on the top end of the door 40, and the lateral wings 11 of the bracket 10 can respectively abut opposite lateral sides of the door 40 to fixedly position the bracket 10 on the door 40. The flexible sheet 20 and the hook body 30 are naturally hung at one lateral side of the door 40 due to its gravity, so that the hook body 30 can hook required decorations, such as Christmas decorations shown in FIG. 4. In this embodiment, the flexible sheet 20 may be charpie, cloth sheet with decorations such as glitter powder, or flexible strip.

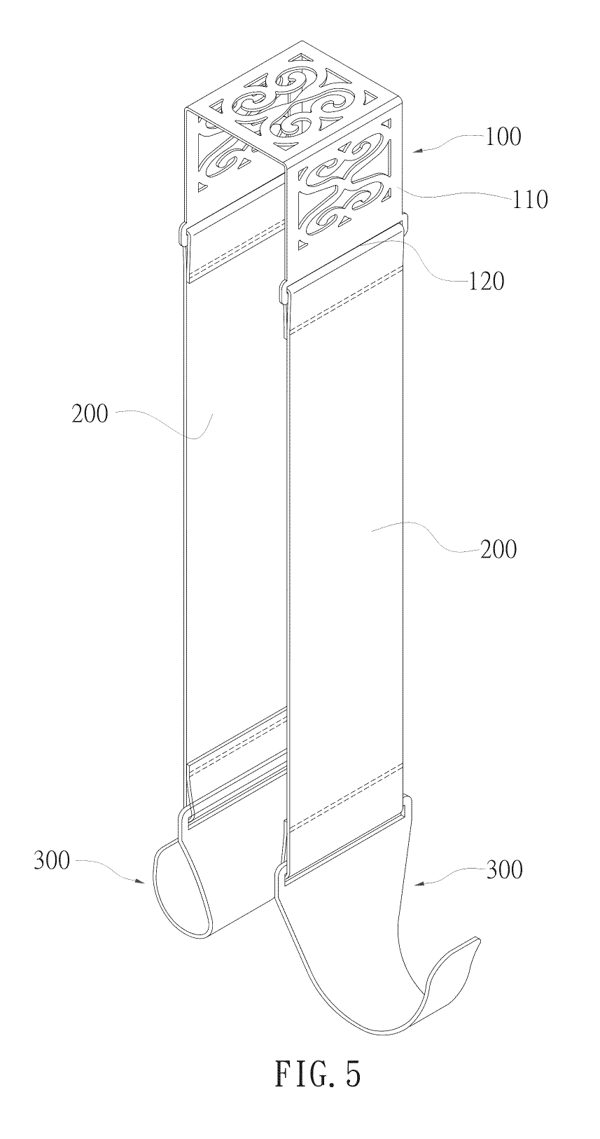

Referring to FIG. 5, the lateral wings 110 of the bracket 100 respectively have a first connecting portion 120, for respectively connecting with an assembly of a flexible sheet 200 and a hook body 300. During its usage, the hook bodies 300 can respectively hook the decorations at opposite sides of the door (not shown), which increases the variations of the hooking device.

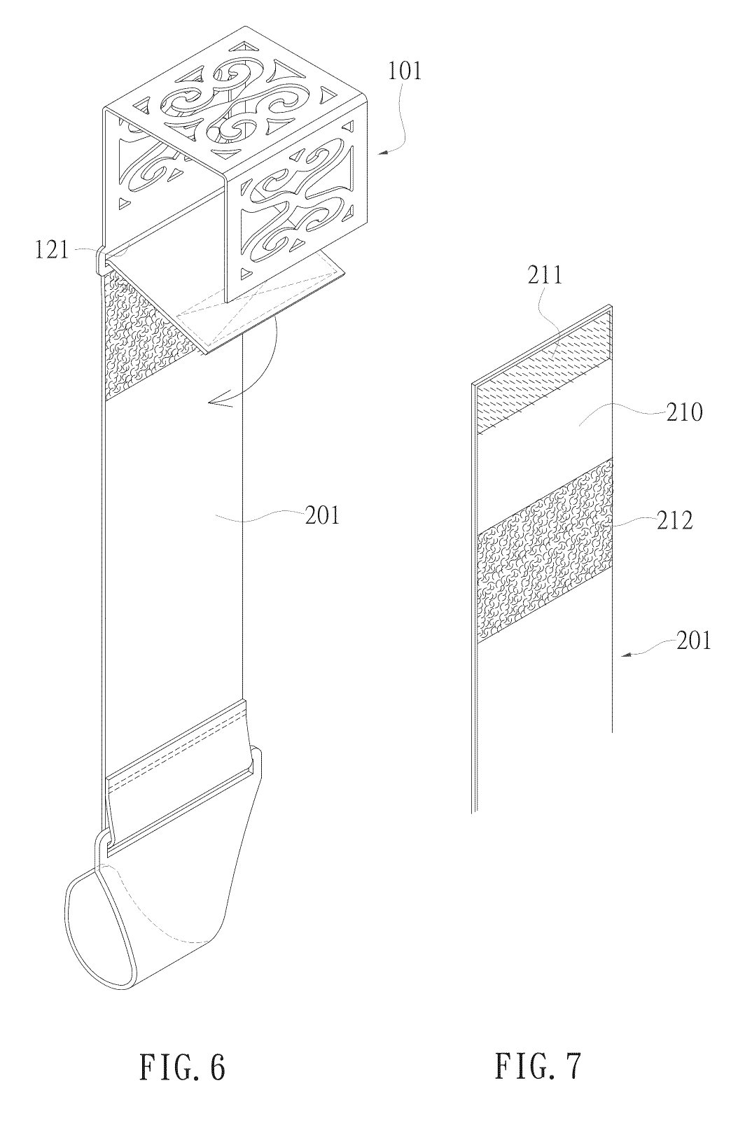

Referring to FIGS. 6 and 7, the first end 210 of the flexible sheet 201 is in a manner of Velcro hook. A terminal end of the first end 210 has a hook surface 211 with a plurality of minute hooks, and a pile surface 212 with a plurality of uncut piles is disposed adjacent to the hook surface 211. The hook surface 211 passes through the first connecting portion 121 of the bracket 101 and is stuck to the pile surface 212. In this embodiment, the length of the flexible sheet 201 can be adjusted according to users' requirement by means of adjusting the position of the hook surface 211 stuck on the pile surface 212.

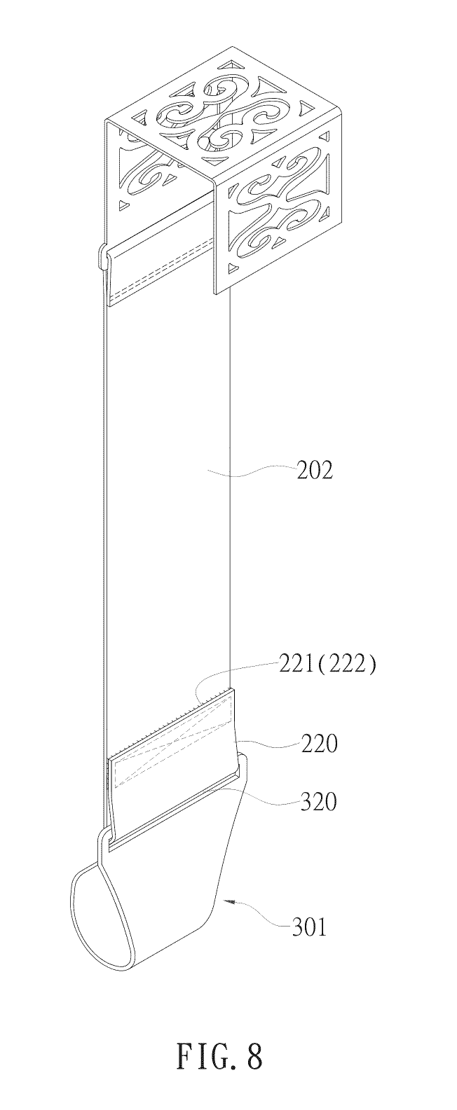

Referring to FIG. 8, the second end 220 of the flexible sheet 202 is in a manner of Velcro hook. A terminal end of the second end 220 has a hook surface 221, and a pile surface 222 is disposed adjacent to the hook surface 221. The hook surface 221 passes through the second connecting portion 320 of the bracket 301 and is stuck to the pile surface 222.

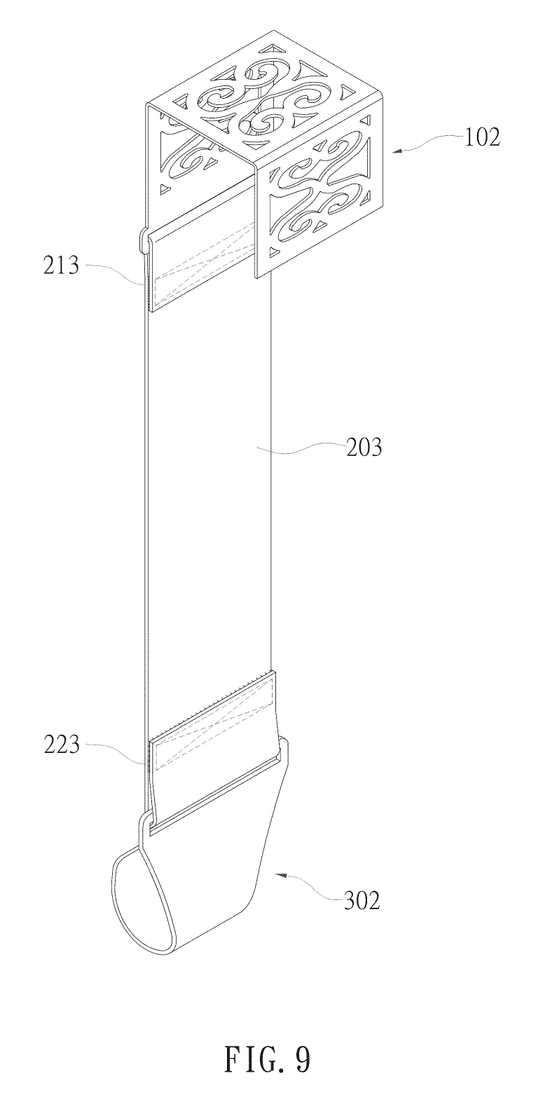

Referring to FIG. 9, both of the first end 213 and the second end 223 of the flexible sheet 203 are in a manner of Velcro hook, for respectively connecting with the bracket 102 and the hook body 302, and by means of adjusting the stick position of the Velcro hook, the length of the flexible sheet 203 can be adjusted according to users' requirement for facilitating the usage of the flexible sheet 203.

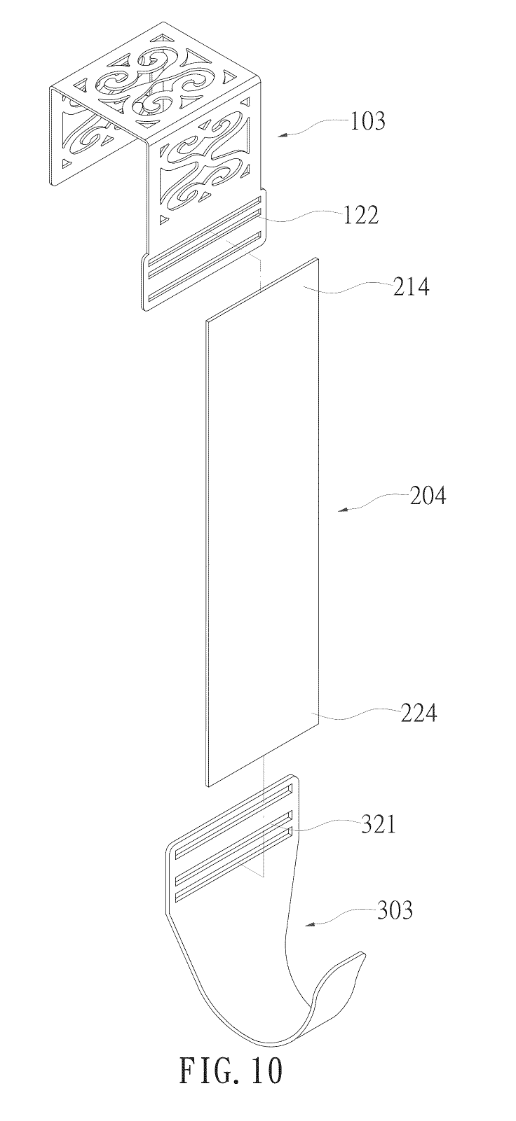

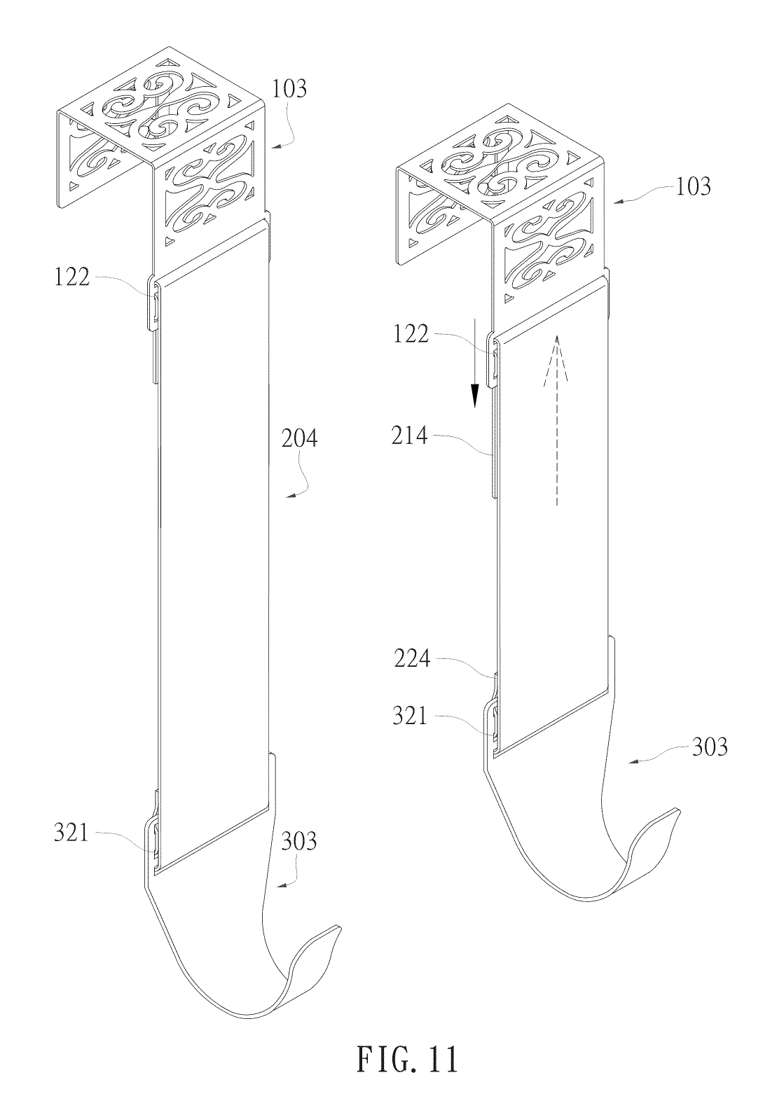

Referring to FIGS. 10 and 11, the first connecting portion 122 of the bracket 103 and the second connecting portion 321 of the hook body 303 respectively have at least two slot holes, such as, three slot holes as shown in FIGS. 10 and 11. The first end 214 and the second end 224 of the flexible sheet 204 respectively pass through the three slot holes of the bracket 103 and the three slot holes of the hook body 203, and are fixed to the flexible sheet 204. By means of adjusting the length of the first end 213 and the second end 224 passed through the slot holes of the bracket 103 and the hook body 203, the length of the flexible sheet 204 can be adjusted according to users' requirement.

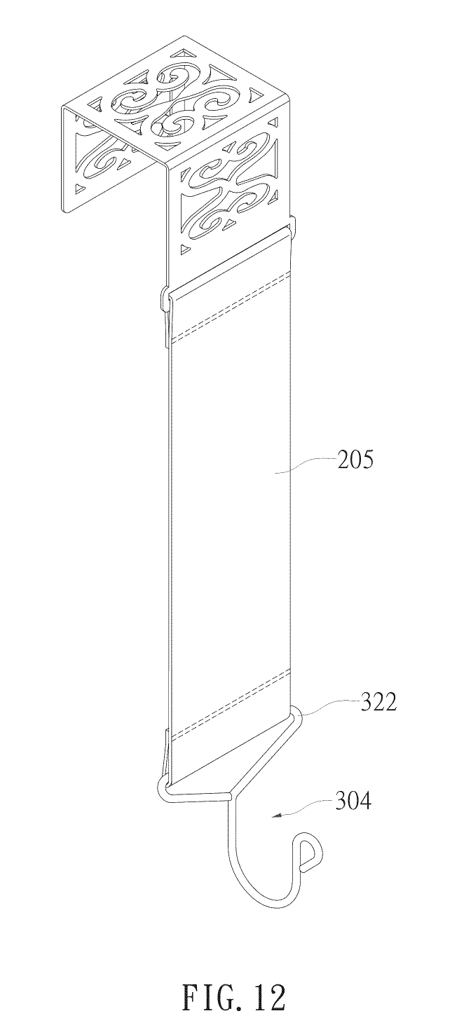

Referring to FIG. 12, the hook body 304 is formed from continuously bending a wire, and a hollowed out second connecting portion 322 is formed on the hook body 304. The flexible sheet 205 passes through, and is bent to surrounding and fix to the second connecting portion 322 of the hook body 304, so that the flexible sheet 205 and the hook body 304 are sewed together.

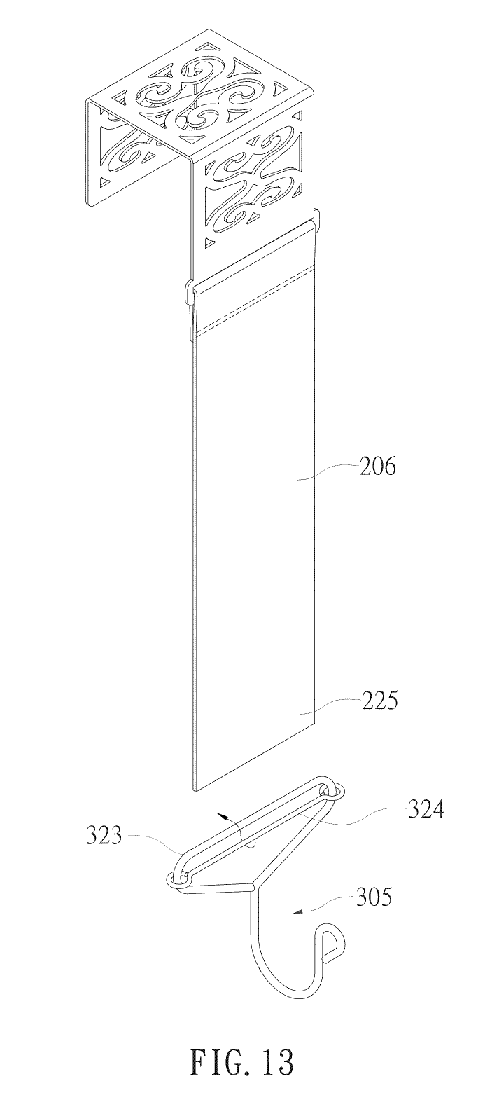

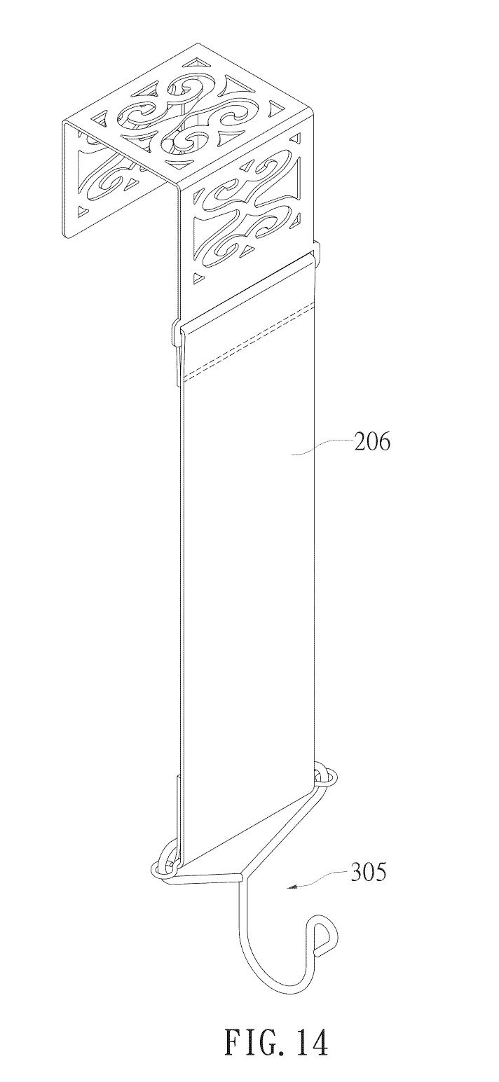

Referring to FIGS. 13 and 14, the hook body 305 is formed from continuously bending a wire, and the hook body 305 has a first clipping bar 324 attached to the hollowed out second connecting portion 323. The first clipping bar 324 is parallel to a linear portion at an end of the second connecting portion 323, and the second end 225 of the flexible sheet 206 can pass through and be bent to dispose between the linear portion at the end of the second connecting portion 323 and the first clipping bar 324, therefore, the flexible sheet 206 can be sewed to the hook body 305 and the length of the flexible sheet 206 can be adjusted.

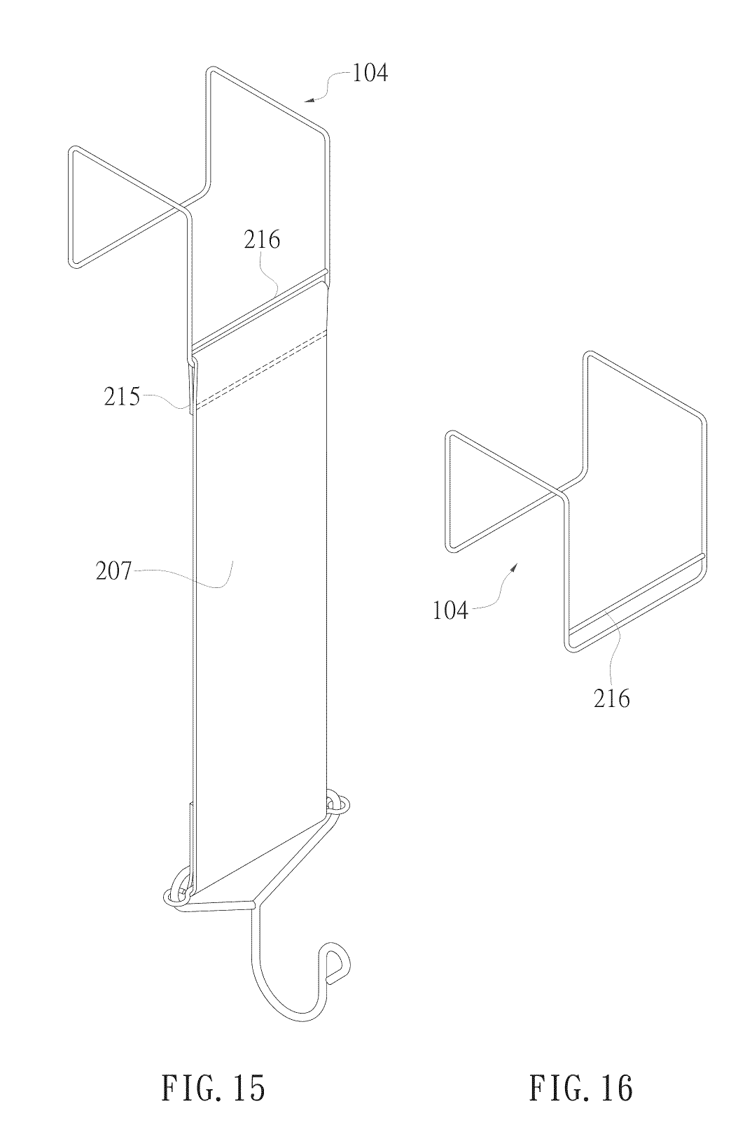

Referring to FIGS. 15 and 16, the bracket 104 may be formed from continuously bending a wire, and the bracket 104 is formed to be a hollowed out body with an n-shaped cross section. The first connecting portion 215 has a second clipping bar 216, and the flexible sheet 207 can be bent and disposed between the bracket 104 and the second clipping bar 216, therefore, the flexible sheet 207 can be sewed to the bracket 104.

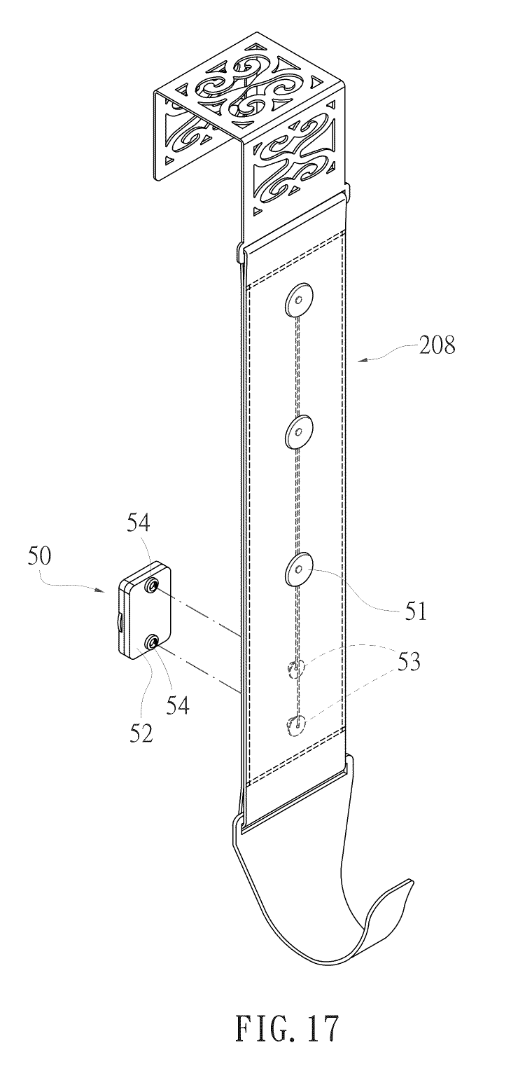

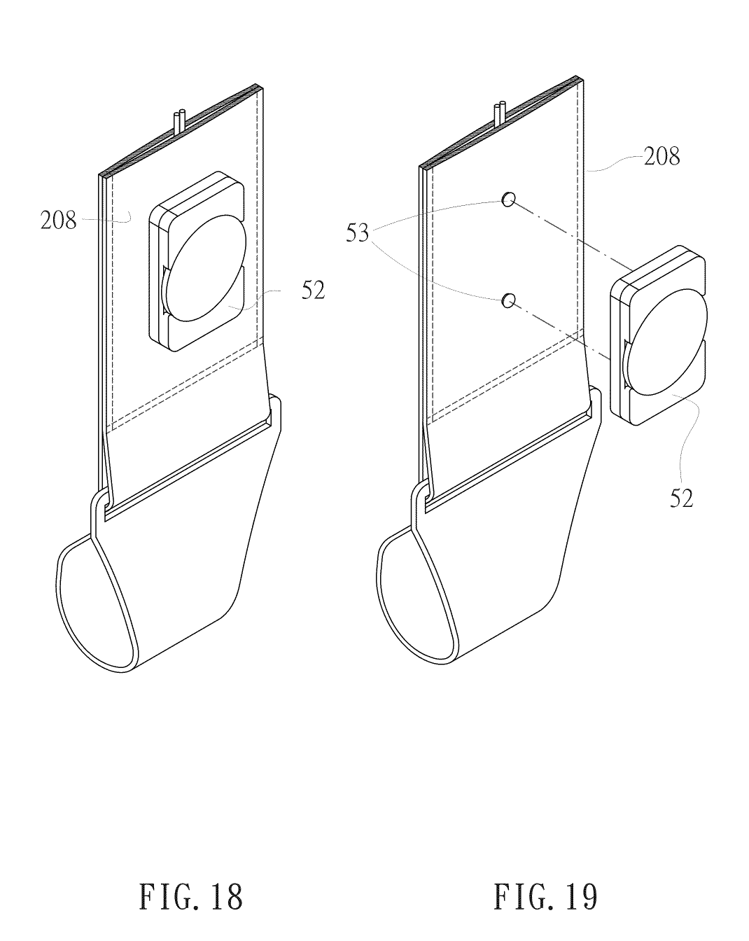

Referring to FIGS. 17 to 19, the flexible sheet 208 may have at least a light source 50 disposed thereon, for increasing the variability of the hooking device. As shown in FIGS. 17 to 19, the light source 50 is formed by series connecting a plurality of LEDs 51, and a positive contact and a negative contact 53 are formed at an end. The flexible sheet 208 has a switch 52 with battery at a surface opposite to light emitting surfaces of the LEDs 51. The switch 52 has two buttons 54 at its rear side, which are capable of connecting with the positive contact and the negative contact 53 for providing a power supply to the LEDs 51, so that the switch 52 is able to turn on or turn off the LEDs 51.

The above description is given by way of example, and not limitation. Given the above disclosure, one skilled in the art could devise variations that are within the scope and spirit of the invention disclosed herein, including configurations ways of the recessed portions and materials and/or designs of the attaching structures. Further, the various features of the embodiments disclosed herein can be used alone, or in varying combinations with each other and are not intended to be limited to the specific combination described herein. Thus, the scope of the claims is not to be limited by the illustrated embodiments.

What is claimed is:

1. A hooking device comprising:
a bracket including two lateral wings respectively formed at its opposite sides, and at least one of the lateral wings having a first connecting portion at its bottom end;
a flexible sheet including a first end and a second end, the first end being connected to the first connecting portion; and
a hook body including a hook portion and a second connecting portion connected with the hook portion, the second connecting portion being connected with the second end of the flexible sheet.

2. The hooking device as claimed in claim 1, wherein the first connecting portion of the bracket includes a slot hole, the first end of the flexible sheet passing through the first connecting portion, and being bent and sewed together with the flexible sheet.

3. The hooking device as claimed in claim I, wherein the second connecting portion of the hook body includes a slot hole, the second end of the flexible sheet passing through the second connecting portion of the hook body, and being bent and sewed together with the flexible sheet.

4. The hooking device as claimed in claim 1, wherein the lateral wings of the bracket respectively have a first connecting portion, for respectively connecting with an assembly of a flexible sheet and a hook body.

5. The hooking device as claimed in claim I, wherein the first end of the flexible sheet is in a manner of Velcro hook, a terminal end of the first end including a hook surface, and a pile surface being disposed adjacent to the hook surface, the hook surface passing through the first connecting portion of the bracket and being stuck to the pile surface.

6. The hooking device as claimed in claim 1, wherein the second end of the flexible sheet is in a manner of Velcro hook, an terminal end of the second end including a hook surface, and a pile surface being disposed adjacent to the hook surface, the hook surface passing through the second connecting portion of the bracket and being stuck to the pile surface.

7. The hooking device as claimed in claim 5, wherein the second end of the flexible sheet is in a manner of Velcro hook, an terminal end of the second end including a hook surface, and a pile surface being disposed adjacent to the hook surface, the hook surface passing through the second connecting portion of the bracket and being stuck to the pile surface.

8. The hooking device as claimed in claim 1, wherein the first connecting portion of the bracket and the second connecting portion of the hook body respectively have at least two slot holes, the first end and the second end of the flexible sheet respectively passing through the slot holes of the bracket and the slot holes of the hook body and being fixed to the flexible sheet.

9. The hooking device as claimed in claim 8, wherein the first connecting portion of the bracket and the second connecting portion of the hook body respectively have three slot holes.

10. The hooking device as claimed in claim 1, wherein the hook body is formed from bending a wire, and a hollowed out second connecting portion being formed on the hook body, the flexible sheet passing through the second connecting portion of the hook body and being fixed to the hook body.

11. The hooking device as claimed in claim 1, wherein the hook body is formed from bending a wire, and the hook body including a first clipping bar attached to a hollowed out second connecting portion, the first clipping bar being parallel to a linear portion at an end of the second connecting portion, the second end of the flexible sheet being bent and disposed between the linear portion at the end of the second connecting portion and the first clipping bar for connecting the flexible sheet to the hook body.

12. The hooking device as claimed in claim 1, wherein the bracket has an n-shaped cross section.

13. The hooking device as claimed in claim 12, wherein the bracket is formed from bending a wire, and the bracket being formed to be a hollowed out body with an n-shaped cross section, the first connecting portion including a second clipping bar, and the flexible sheet passing through and being disposed between the bracket and the second clipping bar for connecting the flexible sheet to the bracket.

14. The hooking device as claimed in claim 12, wherein the bracket is formed from bending a wire, and the bracket being formed to be a hollowed out body with an n-shaped cross section, the first connecting portion including a second clipping bar, and the flexible sheet passing through and being bent to dispose between the bracket and the second clipping bar for the flexible sheet surrounding and being fixed to the bracket.

15. The hooking device as claimed in claim I, wherein the flexible sheet is a cloth strip.

16. The hooking device as claimed in claim 15, wherein the cloth is charpie.

17. The hooking device as claimed in claim 1, wherein the flexible sheet has glitter powder.

18. The hooking device as claimed in claim 15, wherein the flexible sheet has glitter powder.

19. The hooking device as claimed in claim 1, wherein the flexible sheet has at least a light source disposed thereon.

20. The hooking device as claimed in claim 19, wherein the at least a light source is formed by series connecting a plurality of LEDs.

21. The hooking device as claimed in claim 20, wherein the flexible sheet has a switch at a surface opposite to light emitting surfaces of the LEDs, for turning on or turning off the LEDs.
